(19) United States
(12) Patent Application Publication
(10) Pub. No.: US 2023/0213626 A1
(43) Pub. Date: Jul. 6, 2023

(54) LIDAR SYSTEMS WITH REDUCED INTER-CHIP DATA RATE

(71) Applicant: SEMICONDUCTOR COMPONENTS INDUSTRIES, LLC, Phoenix, AZ (US)

(72) Inventors: Ivan KOUDAR, Modrice (CZ); Jan LEDVINA, Tovacov (CZ)

(73) Assignee: SEMICONDUCTOR COMPONENTS INDUSTRIES, LLC, Phoenix, AZ (US)

(21) Appl. No.: 17/646,936

(22) Filed: Jan. 4, 2022

(51) Int. Cl. G01S 7/4863; H01L 31/107; H01L 31/02; G01S 7/4865

(52) U.S. Cl. CPC G01S 7/4863; H01L 31/107; H01L 31/02027; G01S 7/4865

(57) ABSTRACT

A light detection and ranging (LiDAR) system may include a laser and a array of single photon avalanche diodes (SPADs) that are triggered by laser light that reflects off a target scene. The LiDAR system may use the array of SPADs to assemble a raw histogram data. A histogram valid peak detector can be used to filter the raw histogram data to extract only valid histogram peak signals exceeding a threshold value. The histogram valid peak detector may include a raw histogram sum counter, a non-zero bins counter, a background noise floor generator, summing circuits, comparators, and a gating circuit, all controlled by a sequencing circuit. By filtering out noise signals in the raw histogram while only transferring the valid peak signals, data transfer rate requirements between different chips in the overall LiDAR system can be dramatically reduced.

### BACKGROUND

This relates generally to imaging systems, and more specifically, to LiDAR (light detection and ranging) based imaging systems.

LiDAR imaging systems illuminate a target with light (typically a coherent laser pulse) and measure the return time of reflections off the target to determine a distance to the target and light intensity to generate three-dimensional images of a scene. The LiDAR imaging systems include direct time-of-flight circuitry and lasers that illuminate a target. The time-of-flight circuitry may determine the flight time of laser pulses (e.g., having been reflected by the target), and thereby determine the distance to the target. In direct time-of-flight LiDAR systems, this distance is determined for each pixel in an array of single-photon avalanche diode (SPAD) pixels that form an image sensor.

Conventional direct time-of-flight LiDAR systems uses a time correlation technique in which a histogram of time stamps is assembled, where each time stamp represents a detection event. Such detection event may be due to the flight time for each of the laser pulses, ambient light, crosstalk, after pulsing, electronic noise, or other noise sources. By repeating the measurement multiple times, certain time stamps occur more often. This represents the correlation, which translates in the histogram as time values that have higher number of counts (frequency). Transferring the complete (raw) histogram data requires extreme high speed channels and consumes a substantial amount of power. It is within this context that the embodiments herein arise.

### BRIEF DESCRIPTION OF THE DRAWINGS

FIG. 1A is a schematic diagram of an illustrative system that includes a LiDAR imaging system in accordance with some embodiments.

FIG. 1B is a diagram of an illustrative vehicle having a LiDAR imaging system in accordance with some embodiments.

FIG. 2 is a circuit diagram showing an illustrative single-photon avalanche diode (SPAD) pixel in accordance with some embodiments.

FIG. 3 is a circuit diagram of an illustrative array of SPAD pixels in accordance with some embodiments.

FIG. 4 is a circuit diagram of illustrative histogram valid peak detection circuitry in accordance with some embodiments.

FIG. 5A is a timing diagram showing raw histogram bin counts in accordance with an embodiment.

FIG. 5B is a timing showing valid histogram bin counts in accordance with an embodiment.

FIG. 6 is a flow chart of illustrative steps for operating histogram valid peak detection circuitry to output valid histogram bin counts in accordance with some embodiments.

### DETAILED DESCRIPTION

Embodiments of the present invention relate to LiDAR systems having direct time-of-flight capabilities.

Some imaging systems include image sensors that sense light by converting impinging photons into electrons or holes that are integrated (collected) in pixel photodiodes within the sensor array. After completion of an integration cycle, collected charge is converted into a voltage, which is supplied to the output terminals of the sensor. In complementary metal-oxide semiconductor (CMOS) image sensors, the charge to voltage conversion is accomplished directly in the pixels themselves and the analog pixel voltage is transferred to the output terminals through various pixel addressing and scanning schemes. The analog pixel voltage can also be later converted on-chip to a digital equivalent and processed in various ways in the digital domain.

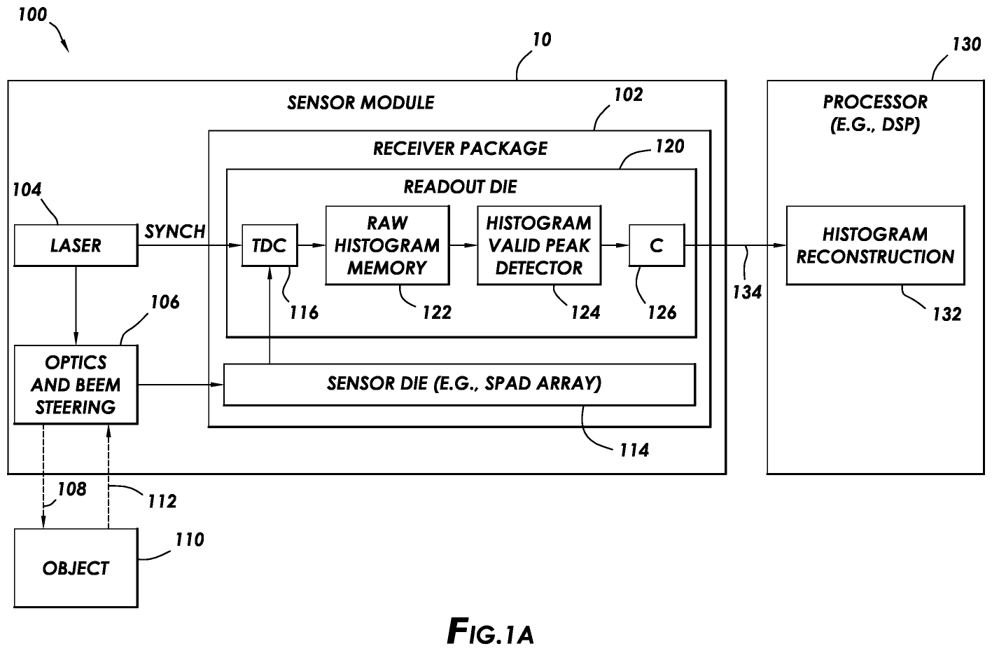

In light detection and ranging (LiDAR) devices (such as the ones described in connection with FIGS. 1-4), on the other hand, the photon detection principle is different. LiDAR devices may include a light source, such as a laser, that emits light toward a target object or scene. A light sensing diode such as a single-photon avalanche diode (SPAD) in the LiDAR devices may be biased slightly above its breakdown point and when an incident photon from the laser (e.g., light that has reflected off of the target object/scene) generates an electron or hole, this carrier initiates an avalanche breakdown with additional carriers being generated. The avalanche multiplication may produce a current signal that can be easily detected by readout circuitry associated with the SPAD. The avalanche process needs to be stopped (quenched) by lowering the diode bias below its breakdown point.

In LiDAR devices, multiple SPAD pixels may be used to measure photon time-of-flight (ToF) from a synchronized light source to a scene object point and back to the sensor, which can be used to obtain a 3-dimensional image of the scene. This method requires time-to-digital conversion circuitry to determine an amount of time that has elapsed since the laser light has been emitted and thereby determine a distance to the target object.

FIG. 1A is a schematic diagram of an illustrative system that includes a LiDAR imaging system. System 100 of FIG. lA may be vehicle safety system (e.g., an active braking system or other vehicle safety system), a surveillance system, a medical imaging system, a general machine vision system, or any other desired type of system.

System 100 includes a LiDAR-based sensor module 10. Sensor module 10 may be used to capture images of a scene and measure distances to objects (also referred to as targets or obstacles) in the scene.

As an example, in a vehicle safety system, information from the LiDAR-based sensor module 10 may be used by the vehicle safety system to determine environmental conditions surrounding the vehicle. As examples, vehicle safety systems may include systems such as a parking assistance system, an automatic or semi-automatic cruise control system, an auto-braking system, a collision avoidance system, a lane keeping system (sometimes referred to as a lane-drift avoidance system), a pedestrian detection system, etc. In at least some instances, a LiDAR module may form part of a semi-autonomous or autonomous self-driving vehicle.

An illustrative example of a vehicle such as an automobile 30 is shown in FIG. 1B. As shown in the illustrative example of FIG. 1B, automobile 30 may include one or more sensor modules 10. The sensor modules 10 may form at least part of a vehicular safety system 100 as discussed above. Sensor modules 10 may be devices or systems with dedicated image capture and/or image processing functions. If desired, a sensor module 10 may perform some or all of the image processing functions associated with a given driver assist operation. A dedicated driver assist processor (e.g., processing circuitry 130 in FIG. 1A) may receive signals from sensor module 10. While various sensor modules 10 can be placed at different locations within automobile 30, processor 130 can be disposed at a central location within automobile 30 (e.g., near the engine bay).

In another suitable example, a sensor module 10 may perform only some or none of the image processing operations associated with a given driver assist function. For example, sensor module 10 may merely capture images of the environment surrounding the vehicle 30 and transmit the image data to processing circuitry 130 for further processing. Such an arrangement may be used for vehicle safety system functions that require large amounts of processing power and memory (e.g., full-frame buffering and processing of captured images).

In the illustrative example of FIG. 1B, a first sensor module 10 is shown mounted on the front of car 30 (e.g., to capture images of the surroundings in front of the car), and a second sensor module 10 is shown mounted in the interior of car 30 (e.g., to capture images of the driver of the vehicle). If desired, a sensor module 10 may be mounted at the rear end of vehicle 30 (i.e., the end of the vehicle opposite the location at which first imaging system 10 is mounted in FIG. 1B). The imaging system at the rear end of the vehicle may capture images of the surroundings behind the vehicle. These examples are merely illustrative. One or more sensor modules 10 may be mounted on or within a vehicle 30 at any desired location(s).

Referring back to FIG. 1A, LiDAR-based sensor module 10 may include a receiver package 102, a laser 104 that emits light 108 to illuminate an external object 110. Laser 104 may emit light 108 at any desired wavelength (e.g., infrared light, visible light, etc.). Optics and beam-steering equipment 106 may be used to direct the light beam from laser 104 towards external object 110. Light 108 may illuminate external object 110 and return to LiDAR module 102 as a reflection 112. One or more lenses in optics and beam-steering 106 may focus the reflected light 112 onto an image sensor die 114 within receiver package 102. As an example, an array of SPAD pixels (sometimes referred to as a SPAD array 114) may be formed on sensor die 114. In single-photon avalanche diode (SPAD) devices, the light sensing diode is biased above its breakdown point. When an incident photon generates an electron or hole, this carrier initiates an avalanche breakdown with additional carriers being generated. The avalanche multiplication may produce a current signal that can be easily detected by readout circuitry associated with the SPAD. The avalanche process can be stopped (or quenched) by lowering the diode bias below its breakdown point. Each SPAD may therefore include a passive and/or active quenching circuit for halting the avalanche. The SPAD pixels may be used to measure photon time-of-flight (ToF) from a synchronized light source (e.g., laser 104) to a scene object point and back to the sensor, which can be used to obtain a 3-dimensional image of the scene.

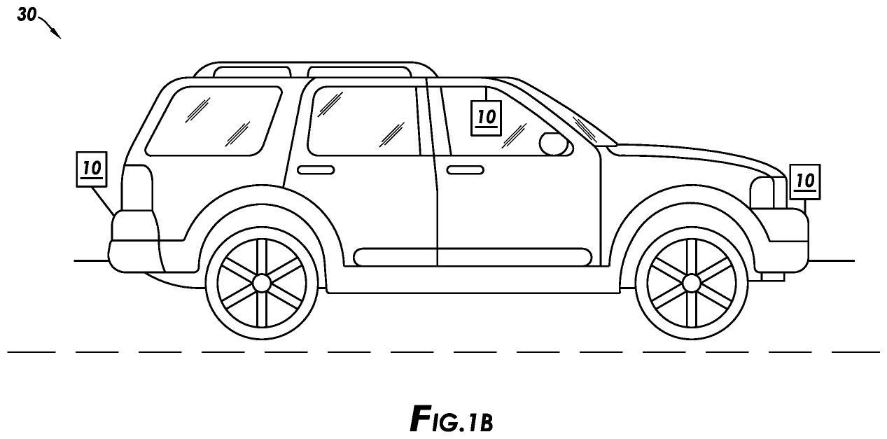

An example of a SPAD pixel is shown in FIG. 2. As shown in FIG. 2, SPAD device 202 includes a SPAD 204 that is coupled in series with quenching circuitry 206 between a first supply voltage terminal 208 (e.g., a positive power supply voltage terminal) and a second supply voltage terminal 210 (e.g., a ground power supply voltage terminal). During operation of SPAD device 202, supply voltage terminals 208 and 210 may be used to bias SPAD 204 to a voltage that is higher than the breakdown voltage. Breakdown voltage is defined as the largest reverse voltage that can be applied without causing an exponential increase in the leakage current in the diode. When SPAD 204 is biased above the breakdown voltage in this manner, absorption of a single-photon can trigger a short-duration but relatively large avalanche current through impact ionization.

Quenching circuitry 206 (sometimes referred to as a quenching element 206) may be used to lower the bias voltage of SPAD 204 below the level of the breakdown voltage. Lowering the bias voltage of SPAD 204 below the breakdown voltage stops the avalanche process and corresponding avalanche current. There are numerous ways to form quenching circuitry 206. Quenching circuitry 206 may be passive quenching circuitry or active quenching circuitry. Passive quenching circuitry may automatically quench the avalanche current without external control or monitoring once initiated. For example, FIG. 2 shows an example where a resistor is used to form quenching circuitry 206. This is an example of passive quenching circuitry. After the avalanche is initiated, the resulting current rapidly discharges the capacity of the device, lowering the voltage at the SPAD to near to the breakdown voltage. The resistance associated with the resistor in quenching circuitry 206 may result in the final current being lower than required to sustain itself. The SPAD may then be reset to above the breakdown voltage to enable detection of another photon.

This example of passive quenching circuitry is merely illustrative. Active quenching circuitry may also be used in SPAD device 202. Active quenching circuitry may reduce the time it takes for SPAD device 202 to be reset. This may allow SPAD device 202 to detect incident light at a faster rate than when passive quenching circuitry is used, improving the dynamic range of the SPAD device. Active quenching circuitry may modulate the SPAD quench resistance. For example, before a photon is detected, quench resistance is set high and then once a photon is detected and the avalanche is quenched, quench resistance is minimized to reduce recovery time.

SPAD device 202 may also include readout circuitry 212. There are numerous ways to form readout circuitry 212 to obtain information from SPAD device 202. Readout circuitry 212 may include a pulse counting circuit that counts arriving photons. Alternatively or in addition, readout circuitry 212 may include time-of-flight circuitry that is used to measure photon time-of-flight (ToF). The photon time-of-flight information may be used to perform depth sensing.

In one example, photons may be counted by an analog counter to form the light intensity signal as a corresponding pixel voltage. The ToF signal may be obtained by also converting the time of photon flight to a voltage. The example of an analog pulse counting circuit being included in readout circuitry 212 is merely illustrative. If desired, readout circuitry 212 may include digital pulse counting circuits. Readout circuitry 212 may also include amplification circuitry if desired.

The example in FIG. 2 of readout circuitry 212 being coupled to a node between diode 204 and quenching circuitry 206 is merely illustrative. Readout circuitry 212 may be coupled to any desired portion of the SPAD device. In some cases, quenching circuitry 206 may be considered integral with readout circuitry 212.

Because SPAD devices can detect a single incident photon, the SPAD devices are effective at imaging scenes with low light levels. Each SPAD may detect how many photons are received within a given period of time (e.g., using readout circuitry that includes a counting circuit). However, as discussed above, each time a photon is received and an avalanche current initiated, the SPAD device must be quenched and reset before being ready to detect another photon. As incident light levels increase, the reset time becomes limiting to the dynamic range of the SPAD device (e.g., once incident light levels exceed a given level, the SPAD device is triggered immediately upon being reset). Moreover, the SPAD devices may be used in a LiDAR system to determine when light has returned after being reflected from an external object.

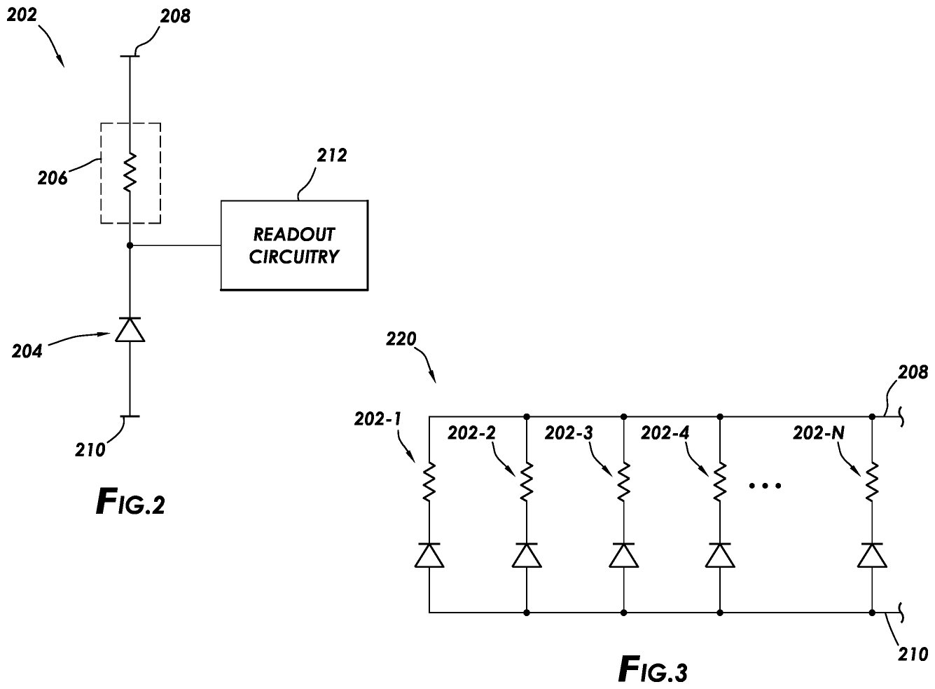

Multiple SPAD devices may be grouped together to help increase dynamic range. The group or array of SPAD devices may be referred to as a silicon photomultiplier (SiPM). Two SPAD devices, more than two SPAD devices, more than ten SPAD devices, more than one hundred SPAD devices, more than one thousand SPAD devices, etc. may be included in a given silicon photomultiplier. An example of multiple SPAD devices grouped together is shown in FIG. 3.

FIG. 3 is a circuit diagram of an illustrative group 220 of SPAD devices 202. The group of SPAD devices may be referred to as a silicon photomultiplier (SiPM).

As shown in FIG. 3 silicon photomultiplier 220 may include multiple SPAD devices that are coupled in parallel between first supply voltage terminal 208 and second supply voltage terminal 210. FIG. 3 shows N SPAD devices 202 coupled in parallel (e.g., SPAD device 202-1, SPAD device 202-2, SPAD device 202-3, SPAD device 202-4, . . . , SPAD device 202-N). More than two SPAD devices, more than ten SPAD devices, more than one hundred SPAD devices, more than one thousand SPAD devices, etc. may be included in a given silicon photomultiplier.

Herein, each SPAD device may be referred to as a SPAD pixel 202. Although not shown explicitly in FIG. 3, readout circuitry for the silicon photomultiplier may measure the combined output current from all of SPAD pixels in the silicon photomultiplier. In this way, the dynamic range of an imaging system including the SPAD pixels may be increased. However, if desired, each SPAD pixel may have individual readout circuitry.

Each SPAD pixel is not guaranteed to have an avalanche current triggered when an incident photon is received. The SPAD pixels may have an associated probability of an avalanche current being triggered when an incident photon is received. There is a first probability of an electron being created when a photon reaches the diode and then a second probability of the electron triggering an avalanche current. The total probability of a photon triggering an avalanche current may be referred to as the SPAD's photon-detection efficiency (PDE). Grouping multiple SPAD pixels together in the silicon photomultiplier therefore allows for a more accurate measurement of the incoming incident light. For example, if a single SPAD pixel has a PDE of 50% and receives one photon during a time period, there is a 50% chance the photon will not be detected. With the silicon photomultiplier 220 of FIG. 3, chances are that two of the four SPAD pixels will detect the photon, thus improving the provided image data for the time period and allowing for a more accurate measurement of the incoming light.

The example of a plurality of SPAD pixels having a common output in a silicon photomultiplier is merely illustrative. In the case of an imaging system including a silicon photomultiplier having a common output for all of the SPAD pixels, the imaging system may not have any resolution in imaging a scene (e.g., the silicon photomultiplier can just detect photon flux at a single point). It may be desirable to use SPAD pixels to obtain image data across an array to allow a higher resolution reproduction of the imaged scene. In cases such as these, SPAD pixels in a single imaging system may have per-pixel readout capabilities. Alternatively, an array of silicon photomultipliers (each including more than one SPAD pixel) may be included in the imaging system. The outputs from each pixel or from each silicon photomultiplier may be used to generate image data for an imaged scene. The array may be capable of independent detection (whether using a single SPAD pixel or a plurality of SPAD pixels in a silicon photomultiplier) in a line array (e.g., an array having a single row and multiple columns or a single column and multiple rows) or an array having more than ten, more than one hundred, or more than one thousand rows and/or columns.

Referring back to FIG. 1A, receiver package 102 may also include a readout integrated circuit die 120 configured to receive image data from sensor die 114. As an example, readout integrated circuit die 120 and sensor integrated circuit die 114 may be vertically stacked with respect to one another. If desired, other multi-die packaging topologies can be used. Since sensor die 114 and readout die 120 are part of the same semiconductor package, the relatively short connection linking die 114 to readout die 120 can handle high data throughout without issue.

Readout die 120 may include time-to-digital converter (TDC) circuitry 116 that uses time values (e.g., between the laser emitting light and the reflection being received by SPAD array 114) to obtain a digital value representative of the distance to object 110. The readout for direct time-of-flight (ToF) LiDAR is achieved using multiple LASER cycles to create raw histogram data based on the direct ToF time-stamps generated by SPAD array 114 and time-to-digital converter (TDC) 116. TDC 116 may be synchronized to laser 104. One or more peaks of the histogram is used to determine the time taken for the LASER signal to travel to the target and return to the sensor. The raw histogram data may be stored in raw histogram memory 122 in the readout die 120. The raw histogram data is defined as a histogram that includes time stamp information associated with laser reflected photons (i.e., photons reflecting back from the external object), ambient light photons, optical crosstalk among the SPAD pixels, thermal noise, and other noise sources. The raw histogram data is therefore sometimes referred to as the complete or unfiltered histogram data.

Readout die 120 may be coupled to one or more downstream processors such as processor 130. Readout die 120 and processor 130 may be separate integrated chips (dies) as an example. Processor 130 may be a digital signal processor (DSP), a microprocessor, a microcontroller, a general purpose processor, a field programmable gate array (FPGA), a host processor, or other suitable types of processors. Transferring the complete histogram data from readout die 120 to signal processor 130 will require channels with extremely high inter-chip data transfer rates in the order of hundreds of Gigabits per second (as an example). Such requirement increases the complexity of the overall system 100 while consuming a substantial amount of power. As described above in connection with FIG. 1B, processor 130 might be mounted at a relatively distant location from each sensor module 10, which makes it even more challenging to transfer high data rates.

In accordance with an embodiment, readout die 120 may be provided with histogram valid peak detection circuitry such as histogram valid peak detector 124 that is configured to identify or extract only the valid peaks from the raw histogram data stored in raw histogram memory 122. Only a small fraction of the raw histogram data carries useful information on the target position of the external object, while the remainder can be considered as noise (e.g., only the laser reflected photos should be considered useful information while the ambient light photons, optical crosstalk, and other noise signals should be filtered out). Histogram valid peak detector 124 can be configured to filter out the un-useful noise signals while only passing through the useful signals to be stored in cache 126. The useful signals representing the laser reflected photons are sometimes referred to as valid peak signals, whereas the un-useful signals representing the peripheral noise signals are sometimes referred to as invalid signals.

Cache 126 may be configured to store the valid peak signals output from histogram valid peak detector 124. The valid peak signals can be conveyed to processor 130 via data path 134. A histogram reconstruction circuit 132 within processor 130 can use the received valid peak signals to reconstruct an accurate copy of the original (raw) histogram. Processor 130 can then use the reconstructed histogram to determine the distance between system 100 and the external object 110. By transferring only the useful (filtered) valid peak signals from readout die (circuit) 120 to signal processor 130, a significant reduction in the data transfer rate of path 134 and a significant reduction of the memory size required for cache 126 can be achieved without histogram skew or data loss at the host processor.

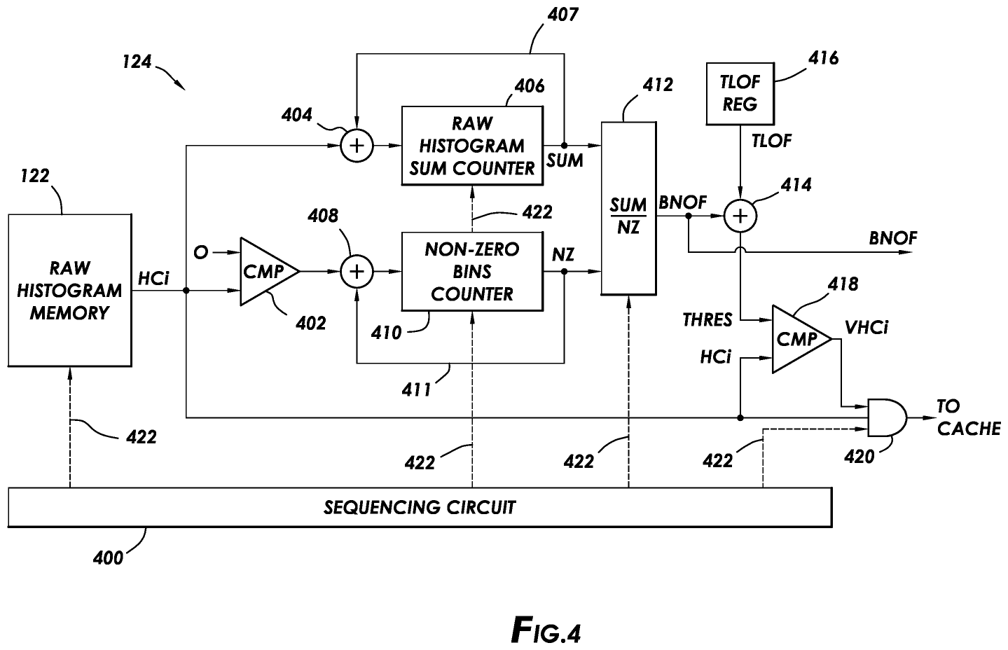

FIG. 4 is a circuit diagram of illustrative histogram valid peak detection circuitry 124. Raw histogram memory 122 may be configured to store the raw (unfiltered) histogram data output from TDC 116 and may be considered as part of histogram valid peak detection circuitry 124 or separate from histogram valid peak detection circuitry 124. As shown in FIG. 4, histogram valid peak detection circuitry 124 may include a comparator circuit such as comparator 402, a first summing circuit such as summing circuit 404, a raw histogram sum counting circuit such as raw histogram sum counter 406, a second summing circuit such as summing circuit 408, a non-zero bins counting circuit such as non-zero bins counter 410, a background noise floor generation circuit such as background noise floor generator 412, a third summing circuit such as summing circuit 414, another comparator circuit such as comparator 418, a final gating circuit such as gate 420, and a sequencing circuit such as sequencer 400.

Raw histogram memory 112 may be configured to output a raw histogram bin count for the i-th bin, where i represents the histogram bin index over time. The i-th raw histogram bin count is denoted as HCi in FIG. 4. Summing circuit 404 may have a first input configured to receive HCi from raw histogram memory 122, an output coupled to raw histogram sum counter 406, and a second input coupled to the output of raw histogram sum counter 406 via feedback path 407. Arranged in this way, raw histogram sum counter 406 can be used to generate a sum output SUM that represents the sum of photons across all bins (sometimes referred to as raw histogram total sum SUM).

Comparator 402 may have a first input configured to receive HCi from raw histogram memory 122, a second input configured to receive a zero threshold value, and an output. The output of comparator 402 will thus only be asserted (e.g., driven high) if a particular bin includes at least one photon. Summing circuit 408 may have a first input coupled to the output of comparator 402, an output coupled to non-zero bins counter 410, and a second input coupled to the output of non-zero bins counter 410 via feedback path 411. Arranged in this way, non-zero bins counter 410 can be used to generate a count output NZ that represents a total number of non-zero bins in the histogram (sometimes referred to as the non-zero bins count NZ).

Background noise floor generator 412 may receive the raw histogram total sum SUM and the non-zero bins count NZ and output a corresponding background noise floor value BNOF. The background noise floor value may be equal to the raw histogram total sum divided by the non-zero bins count (e.g., BNOF may be equal to SUM divided by NZ). Background noise floor generator 412 may therefore be implemented as a division circuit.

Summing circuit 414 may have a first input configured to receive the background noise floor value BNOF from generator 412, a second input configured to receive a threshold level offset value TLOF from threshold level offset (TLOF) register 416, and an output on sum a valid peak threshold level THRES is generated. Valid peak threshold level THRES may thus be equal to BNOF plus TLOF (e.g., THRES=BNOF+TLOF). Summing circuit 414 may therefore sometimes be referred to as a valid peak threshold level generator. The threshold level offset value TLOF may be an adjustable parameter defining a gap between the background noise floor level and the valid peak threshold level.

Comparator 418 may have a first input configured to receive valid peak threshold level THRES from the output of summing circuit 414, a second input configured to receive raw histogram bin count HCi directly from raw histogram memory 122, and an output on which a valid histogram count VHCi is generated. Final gating circuit 420 (represented schematically as a logic AND gate) will only transfer valid histogram counts to cache 126 that are greater than valid peak threshold level THRES. In other words, a histogram count is considered to be valid if HCi is greater than THRES.

Histogram valid peak detection circuitry 124 may only output valid histogram count VHCi and background noise floor value BNOF to signal processor 130. Background noise floor value BNOF may be calculated for each individual SPAD pixel over all measurement frames (laser shots). Thus, there may be a separate instance of histogram valid peak detection circuitry 124 for each SPAD pixel in the LiDAR system. Transferring out only the valid histogram count VHCi and background noise floor value BNOF to signal processor 130 can allow processor 130 to reconstruct the original histogram while significantly reducing the amount of transferred data and thus the data transfer rate requirements. If desired, additional data can also be transferred that can help improve histogram reconstruction accuracy. For example, the raw histogram total SUM can also be transferred. As another example, the non-zero bins count can also be transferred. As another example, histogram variance information can also be transferred.

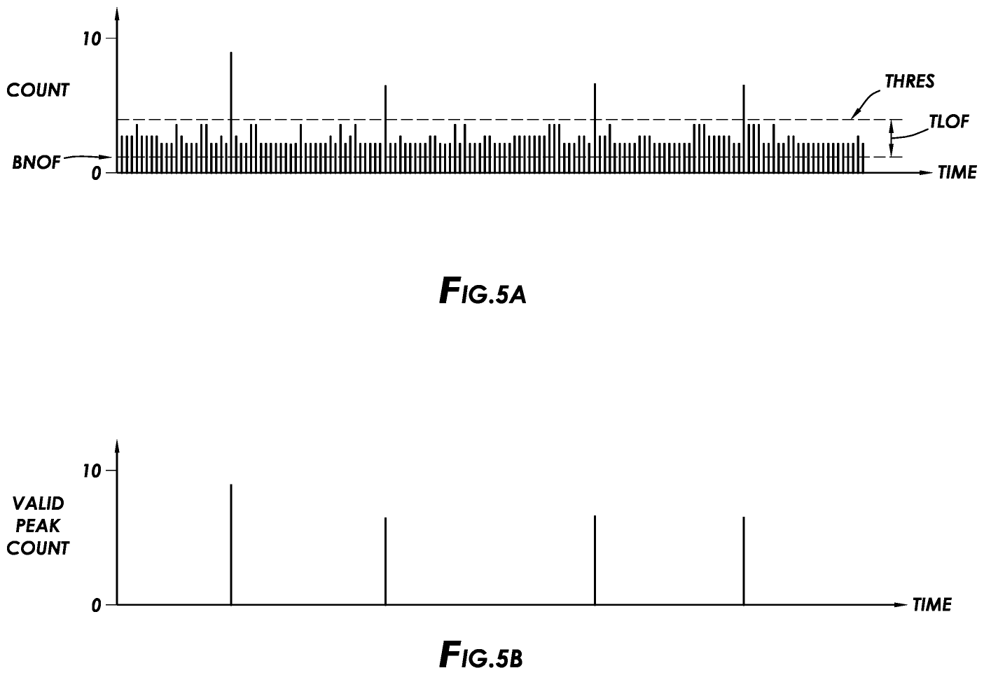

FIG. 5A is a timing diagram showing raw histogram bin counts. The background noise floor level is denoted by the dashed line labeled BNOF. The valid peak threshold level is denoted by the dashed line labeled THRES. A shown in FIG. 5A, the gap or difference between the valid peak threshold level THRES and the background noise floor level BNOF is equal to threshold level offset value TLOF. Transferring all of this raw histogram data from the readout circuit to the signal processor would require extremely high data transfer rates (e.g., hundreds of Gigabits per second).

FIG. 5B is a timing showing valid histogram bin counts. As shown in FIG. 5B only peaks exceeding the valid peak threshold level THRES will be considered a valid peak signal that is stored within cache 126. By transferring only the valid peak signals from the readout circuit to the signal processor, the data transfer rate requirements can be significantly reduced to less than one Gigabit per second (for example). Reducing inter-chip data transfer rates in this way can therefore reduce power consumption while simplifying the overall complexity of the LiDAR system.

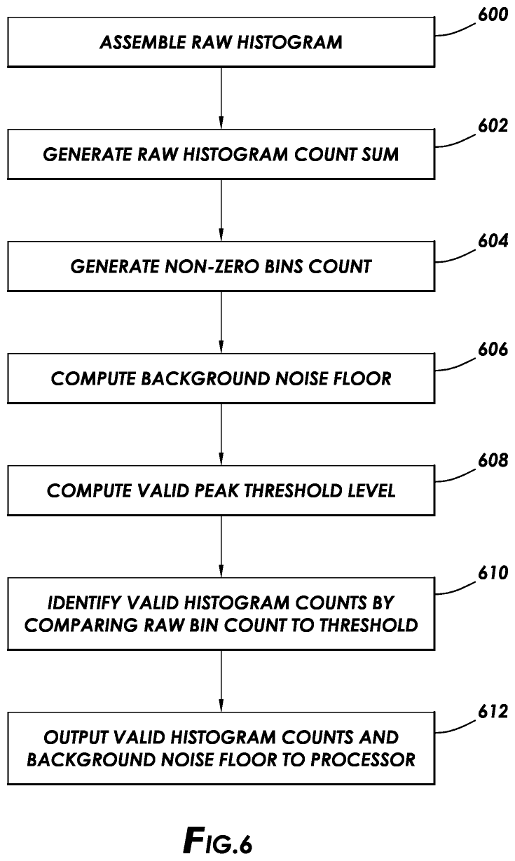

The operations of histogram valid peak detection circuitry 124 can be controlled using sequencing circuit 400 (see FIG. 4). Sequencer 400 may selectively activate portions of circuitry 124 by sending enable or control signals to respective circuit blocks via control path 422. FIG. 6 is a flow chart of illustrative steps for operating histogram valid peak detection circuitry 124 to output valid histogram bin counts, which can be controlled using sequencer 400.

During the operations of block 600, raw histogram data may be assembled and stored within raw histogram memory 122. The raw histogram data may be compiled using direct time-of-flight timestamp information output from time-to-digital converter (TDC) circuitry 116 (see FIG. 1A).

During the operations of block 602, raw histogram sum counter 406 can be used to generate the raw histogram total sum. Raw histogram sum counter 406, along with summing circuit 404, can collectively keep track of the number of all detected photons across the bins.

During the operations of block 604, non-zero bins counter 410 can be used to generate the non-zero bins count. Non-zero bins counter 410, along with summing circuit 408 and comparator 402, can collectively keep track of the number of non-zero bins.

During the operations of block 606, background noise floor generator 412 can be used to generate the background noise floor value. For example, the background noise floor value can be computed by dividing the raw histogram total sum by the non-zero bins count. This is merely illustrative. If desired, the background noise floor value can be computed based on other parameters or using other mathematical functions or equations.

During the operations of block 608, summing circuit 414 may be used to compute the valid peak threshold level. For example, the valid peak threshold level may be computed by adding the background noise floor value and a threshold level offset value. This is merely illustrative. If desired, the valid peak threshold value can be computed based on other parameters or using other mathematical functions or equations.

During the operations of block 610, the final gate circuit can identify or extract valid histogram counts (i.e., valid peak signals) by comparing the raw bin count to the computed valid peak threshold value. Only raw bin counts exceeding the valid peak threshold value will be output to the cache and ultimately transferred off-chip to the signal processor.

During the operations of block 612, histogram valid peak detection circuitry 124 may output the valid histogram bin counts and the background noise floor value to the signal processor. Based on this information, the signal processor can reconstruct or recreate the original histogram to accurately determine the distance between the LiDAR system and the external object/obstacle.

The operations of FIG. 6 are merely illustrative. At least some of the described operations may be modified or omitted; some of the described operations may be performed in parallel; additional processes may be added or inserted between the described operations; the order of certain operations may be reversed or altered; the timing of the described operations may be adjusted so that they occur at slightly different times, or the described operations may be distributed in a system.

The foregoing is merely illustrative of the principles of this invention and various modifications can be made by those skilled in the art. The foregoing embodiments may be implemented individually or in any combination.

What is claimed is:

1. A light detection and ranging (LiDAR) readout integrated circuit, comprising:
a raw histogram memory configured to store raw histogram data that includes at least time-of-flight timestamp information;
histogram valid peak detection circuitry configured to filter the raw histogram data to output corresponding valid histogram counts by monitoring a number of non-zero bins in the raw histogram data; and
a cache configured to receive and store the valid histogram counts output from the histogram valid peak detection circuitry.

2. The light detection and ranging (LiDAR) readout integrated circuit of claim 1, wherein the histogram valid peak detection circuitry comprises:
a raw histogram sum counter configured to output a raw histogram total sum for a plurality of bins in the raw histogram data.

3. The light detection and ranging (LiDAR) readout integrated circuit of claim 2, wherein the histogram valid peak detection circuitry further comprises:
a summing circuit coupled to the raw histogram sum counter in a feedback arrangement.

4. The light detection and ranging (LiDAR) readout integrated circuit of claim 2, wherein the histogram valid peak detection circuitry further comprises:
a non-zero bins counter configured to output a non-zero bins count representing the number of non-zero bins in the raw histogram data.

5. The light detection and ranging (LiDAR) readout integrated circuit of claim 4, wherein the histogram valid peak detection circuitry further comprises:
a summing circuit coupled to the non-zero bins counter in a feedback arrangement.

6. The light detection and ranging (LiDAR) readout integrated circuit of claim 5, wherein the histogram valid peak detection circuitry further comprises:
a comparator having a first input coupled to the raw histogram memory, a second input configured to receive a zero threshold value, and an output coupled to the summing circuit.

7. The light detection and ranging (LiDAR) readout integrated circuit of claim 4, wherein the histogram valid peak detection circuitry further comprises:
a background noise floor generation circuit configured to:
receive the raw histogram total sum and the non-zero bins count; and
generate a background noise floor value based on the raw histogram total sum and the non-zero bins count.

8. The light detection and ranging (LiDAR) readout integrated circuit of claim 7, wherein the background noise floor generation circuit is configured to generate the background noise floor value by dividing the raw histogram total sum by the non-zero bins count.

9. The light detection and ranging (LiDAR) readout integrated circuit of claim 7, wherein the histogram valid peak detection circuitry further comprises:
a summing circuit configured to:
receive the background noise floor value and a threshold level offset value; and
generate a valid peak threshold level by summing the background noise floor value and a threshold level offset value.

10. The light detection and ranging (LiDAR) readout integrated circuit of claim 9, wherein the histogram valid peak detection circuitry further comprises:
a register configured to output the threshold level offset value, wherein the threshold level offset value is adjustable.

11. The light detection and ranging (LiDAR) readout integrated circuit of claim 9, wherein the histogram valid peak detection circuitry further comprises:
a comparator having a first input configured to receive the valid peak threshold level, a second input coupled to the raw histogram memory, and an output on which the valid histogram counts are generated.

12. The light detection and ranging (LiDAR) readout integrated circuit of claim 11, wherein the valid histogram counts and the background noise floor value are transferred off-chip to an external processor.

13. The light detection and ranging (LiDAR) readout integrated circuit of claim 1, wherein the light detection and ranging (LiDAR) readout integrated circuit is part of a light detection and ranging system for a vehicle.

14. A method for operating a light detection and ranging (LiDAR) system, comprising:
assembling raw histogram data that includes at least time-of-flight timestamp information;
counting a number of non-zero bins in the raw histogram data;
filtering the raw histogram data to obtain valid histogram counts based on the number of non-zero bins; and
conveying the valid histogram counts to a digital signal processor via an inter-chip data path.

15. The method of claim 14, further comprising:
generating a raw histogram total sum for a plurality of bins in the raw histogram data.

16. The method of claim 15, further comprising:
computing a background noise floor value based on the raw histogram total sum and the number of non-zero bins.

17. The method of claim 16, wherein computing the background noise floor value comprises dividing the raw histogram total sum by the number of non-zero bins.

18. The method of claim 16, further comprising:
computing a valid peak threshold level by adding the background noise floor value and an adjustable threshold level offset value.

19. The method of claim 18, wherein filtering the raw histogram data comprises comparing the raw histogram data to the valid peak threshold level to identify the valid histogram counts.

20. A system comprising:
a sensor die having an array of single-photon avalanche diodes;
a readout die configured to receive time-of-flight timestamp information from the sensor die, wherein the readout die comprises:
a raw histogram memory configured to store raw histogram data assembled based on the received time-of-flight timestamp information; and
histogram valid peak detection circuitry configured to filter the raw histogram data to output corresponding valid histogram counts and further configured to output a background noise floor value; and
a processor configured to receive the valid histogram counts and the background noise floor value from the readout die.
